(19) United States
(12) Patent Application Publication
(10) Pub. No.: US 2018/0339323 A1
(43) Pub. Date: Nov. 29, 2018

(54) Method of Recycling Single or Limited Use Items

(71) Applicant: Science Medical, LLC, Saratoga Spring, UT (US)

(72) Inventors: Jeff Bullock, Saratoga Springs, UT (US); John K. Bullock, Saratoga Springs, UT (US)

(21) Appl. No.: 15/551,886

(22) PCT Filed: Apr. 17, 2017
(86) PCT No.: PCT/US17/27990

§ 371 Date: Aug. 17, 2017

Related U.S. Application Data
(60) Provisional application No. 62/296,527, filed on Feb. 17, 2016.

(51) Int. Cl. B09B 3/00; B29B 17/02; B02C 11/08

(52) U.S. Cl. CPC B09B 3/0091; B29B 2017/001; B02C 11/08; B29B 17/02

(57) ABSTRACT

A method of recycling single or limited use items may include providing a one or more single or limited use items to a buyer, collecting the single or limited use items from the buyer when the single or limited use items are soiled, and producing oil and/or one or more petroleum-based product from the used items.

### BACKGROUND OF THE INVENTION

The present invention relates generally to a method of recycling single or limited use items. In some embodiments, the method of recycling single or limited use items may include one or more of the following: providing the items to a buyer, collecting items from the buyer when the items are soiled, and recycling the used items by producing oil and/or one or more petroleum-based products from the items.

Properly cleaning spa, salon, hospitality, sportswear, and retail items may be time-consuming, harmful to the environment due to high energy and water usage, and costly. Properly cleaning soiled linens, medical clothing, and other items that have an increased risk of storing contaminants and microorganisms may also be time-consuming, costly, and harmful to the environment. In further detail, procedures for collection, transportation, processing, and storage of these items may be extensive and burdensome. As an example, soiled hospital bed linens constitute one of the largest concentrations of microbial contamination in the hospital environment. An estimated six billion pounds of hospital bed linens are used each year in American hospitals. This abundance of soiled hospital linens places an enormous responsibility on the laundry department whose job is to return these soiled linens to service in a clean and safe condition, free of contaminants and microorganisms, which otherwise could cause cross-infection throughout the facility. Cleaning the soiled hospital linens may require use of tens to hundreds of millions of gallons of water in a single year by a single facility. Further, adequate procedures for collection, transportation, processing, and storage of clean and soiled hospital linens and clothes are a necessary protocol in order to limit the possibility of infection in users and staff who may be unusually susceptible. The present invention addresses and solves these shortcomings.

### BRIEF SUMMARY OF THE INVENTION

The present invention relates generally to a method of recycling single or limited use items. In some embodiments, the method of recycling single or limited use items may include one or more of the following: providing the items to a buyer, collecting the used items from the buyer when the items are soiled, and recycling the items by producing oil and/or one or more petroleum-based products from the used items.

In some embodiments, the single or limited use items may be used in a health care setting, where the items, after a single use or a determined period of limited use, may be soiled with a bodily fluid, biohazard, infectious substance, contaminant, and/or microorganism. For example, the used items may include bed linens and/or medical clothing. In some embodiments, the used items may also include luxury items used in a hospitality setting. In some embodiments, the used items may include wash cloths, towels, blankets, drapes, sheets designed for assisting healthcare workers to transport patients, slippers, sandals, robes, gowns, scrubs, mattress pad protectors, duvet covers, shoe covers or booties, overalls, tunics, aprons, lab coats, slippers, clean room coveralls, etc.

In some embodiments, the method of recycling single or limited use items may include separating and sorting components of each of the used items and sorting the components into groups based on an ability of the components to be recycled in a similar manner. A particular single or limited use item that includes a bed linen may include one or more of the following separable components, for example: a top portion, a webbing, one or more handles, a netting, and other components. One or more of the components may be constructed of a plastic material, which may be recyclable by converting the plastic material to oil and/or one or more petroleum-based products. In some embodiments, the petroleum-based products may include fuel. In some embodiments, the plastic material may be recyclable by breaking down the plastic material into one or more components of the plastic material and/or converting the plastic material to another form of plastic material. For example, the plastic material may be broken down into and/or converted into plastic fibers and/or plastic pellets.

### BRIEF DESCRIPTION OF SEVERAL VIEWS OF THE DRAWINGS

In order that the above-recited and other features and advantages of the invention are obtained and will be readily understood, a more particular description of the invention briefly described above will be rendered by reference to specific embodiments thereof, which are illustrated in the appended drawings. These drawings depict only typical embodiments of the invention and are not therefore to be considered to limit the scope of the invention.

FIG. 1 is a flow diagram of an example business method of recycling single or limited use items, according to some embodiments.

### DETAILED DESCRIPTION OF THE INVENTION

Single or limited use items in accordance with the present invention include items intended for a single use or limited use over a determined time. In some instances, the items may be intended for single use because use a second time would pose a significant health hazard due to presence of blood, a bodily fluid, a biohazard, an infectious substance, a contaminant, and/or a microorganism on the items. In some instances, the items may be intended for single use because they are luxury items provided in a hospitality setting where cleanliness and freshness are a priority. The single use items may be used once and disposed of, reducing a need to engage in extensive cleaning or sterilizing, which may save water, energy, and other resources. The single use items may also be recycled, which may decrease an environmental impact and allow resources to be reused.

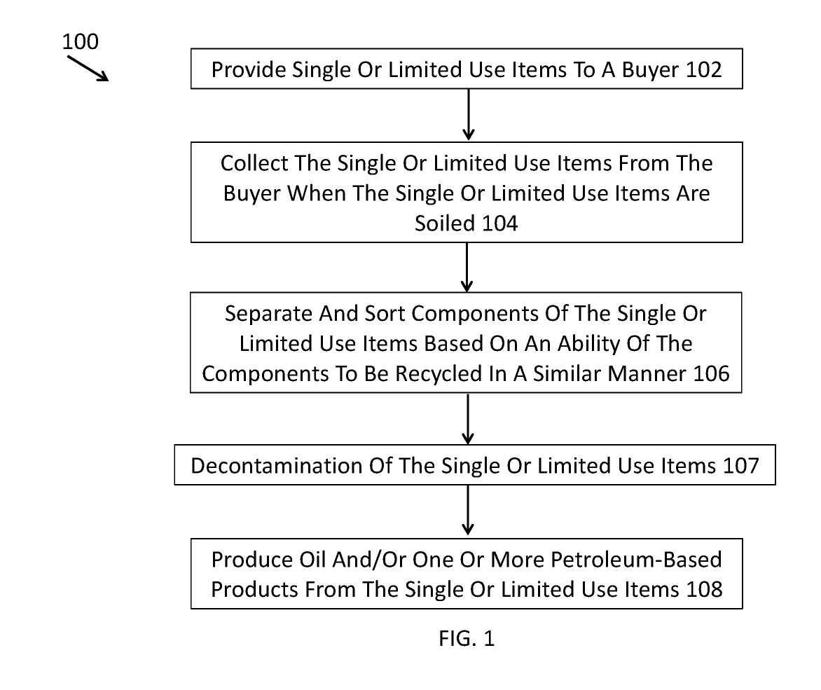

FIG. 1 is a flow diagram of an example business method 100 of recycling single or limited use items, according to some embodiments. The business method 100 may begin at block 102 in which single or limited use items may be provided to a buyer. In some embodiments, providing the items to the buyer may include manufacturing the single or limited use items and/or obtaining the items from a manufacturer.

The terms “single use” or “limited use,” as referred to in the present disclosure, are understood to describe a product intended for a single use, use for a specific period of time, and/or use by a single user. In some embodiments, the single or limited use items provided to the buyer may include bed linens. The term “bed linen” as referred to in the present disclosure is understood to describe any bed covering, such as, for example, fitted sheets, flat sheets, top sheets, bottom sheets, coverlets, bedspreads, duvet covers, mattress pad protectors, blankets, throws, blankets, comforters, duvets, duvet covers, pillows, pillow cases, pillow shams, and bed skirts, as well as other types of compatible bedding.

In some instances, the bed linens may be used in a medical or health care setting, where the bed linens, after a single or limited use, may be soiled with or have an increased risk of being soiled with a bodily fluid, an infectious substance, a biohazard, a contaminant, and/or a microorganism. For example, the bed linens may be used in health care facilities, hospitals, clinics, Long Term Acute Care Facilities, Skilled Nursing Centers, Assisted Living Centers, nursing homes, isolation wards, urgent care centers, etc. The bed linens may be used in medical settings with a high daily turnover of users, such as, for example, in emergency care wards, on gurneys and ambulance stretchers, and in outpatient and support services, such as, for example, diagnostics and treatment centers, X-ray, and MRI facilities.

In some instances, the bed linens may be used in a hospitality setting, such as, for example, a hotel, motel, hostel, home, cruise liners, vacation rental, bed and breakfast, etc. In some hospitality settings, users may desire bed linens to be used one time such that they have never been previously used, for example. Also, in some hospitality settings, cleaning the bed linens may be time-consuming and/or uneconomical, particularly where a volume of bed linens to be cleaned is large.

In some embodiments, the single or limited use items provided to the buyer may include any type of clothing items. For example, after a single or limited use the clothing items may be soiled with or have an increased risk of soiling with a bodily fluid, an infectious substance, a contaminant, and/or a microorganism. For example, the clothing items may be used in a medical setting, such as gowns, coats, clean room coveralls, aprons, scrubs, shields, shoe covers, slippers, hair caps, etc. In some embodiments, the clothing items may include hospitality items that are for single or limited use. For example, the clothing items may include bathrobes, robes, towels, slippers, etc., which may be provided by a hotel or another hospitality setting. In some embodiments, the single or limited use items may include prison uniforms, sports uniforms, fire uniforms, EMT uniforms, hospitality uniforms, sportswear, etc. The sportswear may include jerseys, swimwear, gym shorts, etc.

In some embodiments, the single or limited use items may include tablecloths, drapes, washcloths, towels, blankets, gowns, scrubs, tunics, aprons, slippers, robes, sandals, shower caps, bath mats, etc. The single or limited use items may be used in any setting, such as, for example, spas, day spas, salons, hospitality settings, retail, prisons, state facilities, sports facilities, etc.

In some embodiments, the single or limited use items provided to the buyer may include items constructed of in whole or in part of fabric. In some embodiments, the single or limited use items may be constructed of a nonwoven fabric. As used in the present disclosure, the term “nonwoven fabric” is understood to include material made from long fibers, bonded together by chemical, mechanical, heat or solvent treatment. In some embodiments, the single or limited use items may be constructed of a spunlace and/or a hydroentanglement fabric material. In some embodiments, the single or limited use items may be constructed of one or more of the following fabric materials, which may be capable of being converted to oil and/or one or more petroleum-based products: polyethylene terephthalate, polypropylene, polyester, polystyrene, and cotton. Additionally or alternatively, the single or limited use items may be constructed of another fabric material capable of being converted to oil and/or one or more petroleum-based products. In some embodiments, the one or more petroleum-based products may include fuel.

In some embodiments, the single or limited use items may include one or more properties that improve the user experience. In some embodiments, a particular single or limited user item may include or correspond to one or more disposable bed linens described in PCT/US2015/061701, which is hereby incorporated by reference.

In some embodiments, the single or limited use items may include one or more components. For example, in response to a particular item including a bed linen, the components may include one or more of the following: a top portion, a webbing, one or more handles, a netting, any other components of the bed sheets described in U.S. patent application Ser. No. 15/255,079, filed Sep. 1, 2016, which is hereby incorporated by reference, or any other components.

In some embodiments, one or more of the components may be recyclable. In some embodiments, one or more of the components may be recyclable by producing oil and/or one or more petroleum-based products from the components. In some embodiments, one or more of the components may be recyclable by breaking down the components and/or converting the components to another form. For example, the one or more components may be constructed of a plastic material, and the plastic material may be broken down to and/or converted to plastic fibers and/or plastic pellets.

In some embodiments, some of the components may be made of different materials. For example, in some instances, various of the components may be recyclable, and other various of the components may be biodegradable. In some embodiments, the components of the bed sheet may include different types of recyclable materials for which separation and sorting is required prior to recycling. In some embodiments, one or more of the components may be constructed of one or more of the following fabric materials, which may be recyclable by producing oil and/or one or more petroleum-based products: polyethylene terephthalate, polypropylene, polyester, polystyrene, and cotton. Additionally or alternatively, one or more of the components may be constructed of another fabric material, which may be similar to the fabric materials, which may be recyclable by producing oil and/or one or more petroleum-based products from the components. Block 102 may be followed by block 104.

At block 104, the single or limited use items may be collected from the buyer when the used items are soiled. In some embodiments, the items may be soiled in response to being used a single time, for a specific period of time, and/or by a single user. In some embodiments, the single or limited use items may be soiled due to a presence of blood, a bodily fluid, an infectious substance, a biohazard, a contaminant, and/or microorganism on the items. The used items may be collected from the buyer in response to a request from the buyer or at a designated time. Block 104 may be followed by block 106.

At block 106, the components of the single or limited use items may be separated and sorted based on an ability of the components to be recycled in a similar manner, which may be based on a similarity of a material of the components. Additionally or alternatively, the components of the used items may be sorted based on an ability of the components to be recycled and an ability of the components to biodegrade. Recycling the components may include producing oil from the components, producing one or more petroleum-based products from the components, or another method of recycling. In some embodiments, the ability of each of the components to be recycled in the similar manner may be reflected in a recycling code of the corresponding component. In some embodiments, the components of the used items may be sorted based on the recycling codes of the components.

In some embodiments, one or more of the components of the single or limited use items may be interconnected in a manner that facilitates separation of the components. For example, a chain stitch (which is commonly used on sacks of food products, such as flour or dog food) may be employed. In such cases, a tab or other structure can be secured to the end of the chain stitch to facilitate the removal of the chain stitch and the separation of the components interconnected by the chain stitch. In this way, the components of different materials may be separated and disposed of properly such as, for example, by sorting the different materials according to an ability of the components to be recycled in a similar manner.

In some embodiments, the top portion and/or possibly a sidewall of the bed linen may be formed of a polyester-based material or of a biodegradable material (e.g., a cotton-based material) while the remaining components (i.e., the webbing, the handles, the netting, and possibly the sidewall) may be formed of a polypropylene material. In such cases, the top portion may be configured to be easily separated from the other components for independent recycling. In some embodiments, at least some of the components (including the top portion) may be formed of lyocell (which is the generic term for Tencel®) or other similar biodegradable material. In some embodiments, polypropylene may be preferred for the webbing and the netting due to its strength. In some embodiments, handles 104 may be formed of a rubber material.

In some embodiments, block 106 may be followed by a decontamination step, at block 107. A decontamination step may include any treatment or series of treatments to a contaminated polyester-based and/or biodegradable material, wherein the treatment eliminates all forms of life and other biological agents that may be present, including but not limited to fungi, bacteria, viruses, spore forms, prions, unicellular eukaryotic organisms, etc. In one embodiment, the contaminated material is heat treated. In one embodiment, the contaminated material is dry heated. In one embodiment, the contaminated material is heat treated with steam. In one embodiment, the contaminated material is heat treated by boiling. In one embodiment, the contaminated material is dry heat treated for at least two hours at 160° C. In one embodiment, the contaminated material is heated to a temperature of from approximately 160° C. to approximately 350° C. In one embodiment, the contaminated material is heated to a temperature in excess of 350° C.

In some embodiments, the decontamination step may include chemical sterilization, such as by ethylene oxide gas treatment, nitrogen dioxide gas treatment, ozone treatment, glutaraldehyde and formaldehyde treatment, hydrogen peroxide treatment, or paracetic acid treatment. The decontamination step may further include radiation sterilization utilizing at least one of non-ionizing or ionizing radiation. Block 107 may be followed by block 108.

At block 108, oil and/or one or more petroleum-based products may be produced from the single or limited use items. The oil and/or the petroleum-based products may be produced from the single or limited use items in various ways. Where the items are constructed from a plastic material, such as, for example, polyethylene terephthalate, oil and/or the petroleum-based product may be produced from the used items using anhydrous pyrolysis or another method. Petroleum-based products may include, for example, asphalts, gasolines, fuel oils, kerosene, liquefied petroleum gas, lubricants, naphthas, waxes, etc.

In some embodiments, the single or limited use items may be constructed of a plastic material. The plastic material may be recyclable by breaking down the plastic material into one or more components of the plastic material and/or converting the plastic material to another form of plastic material. For example, the plastic material may be broken down into and/or converted into plastic fibers and/or plastic pellets.

Although illustrated as discrete blocks, various blocks may be divided into additional blocks, combined into fewer blocks, or eliminated, depending on the desired implementation. For example, in some embodiments, block 106 may be eliminated. For example, block 102 may be eliminated. In further detail, in some embodiments, the single or limited use items may be provided by a third party.

1. A method of recycling a single or limited use item, comprising:
collecting the single or limited use item from the buyer when the single or limited use item is soiled; and
producing oil or one or more petroleum-based products from the single or limited use item.

2. The method of claim 1, further comprising providing a single or limited use item to a buyer.

3. The method of claim 1, further comprising separating and sorting components of the single or limited use item and sorting the components into groups based on an ability of the components to be recycled in a similar manner.

4. The method of claim 3, wherein the components are interconnected via a chain stitch to facilitate easy separation of the components.

5. The method of claim 1, wherein the single or limited use item is selected from the group consisting of: a bed linen, and a fabric.

6. The method of claim 5, wherein the bed linen comprises a therapeutic sensory feature selected from the group consisting of a color, a scent, a texture, and a pattern.

7. The method of claim 5, wherein the bed linen comprises a plastic material.

8. The method of claim 5, wherein the bed linen comprises: a top portion;
a webbing secured to the top portion; and
one or more handles secured to the webbing.

9. The method of claim 8, further comprising separating the top portion, the webbing, and the one or more handles and sorting the top portion, the webbing, and the one or more handles based on an ability of the top portion, the webbing, and the one or more handles to be recycled in a similar manner.

10. The method of claim 8, wherein the webbing comprises separate strips of webbing that extend along opposite sides of the top portion.

11. The method of claim 8, wherein the one or more handles comprise at least one pair of handles positioned on each side of the top portion.

12. The method of claim 1, wherein single or limited use item is soiled by blood or a bodily fluid.

13. The method of claim 12, wherein the single or limited use item is a medical clothing.

14. The method of claim 13, wherein the medical clothing is constructed of one or more of the following: polyethylene terephthalate, polypropylene, polystyrene, and polyester.

15. The method of claim 14, wherein producing oil or a petroleum product from the single or limited use item comprises pyrolysis.

16. The method of claim 1, wherein the single or limited use item includes a luxury items used in a hospitality setting.

17. The method of claim 16, wherein the luxury item is selected from the group consisting of a bathrobe, a towel, and a pair of slippers.

18. The method of claim 17, wherein the luxury item is constructed of one or more of the following: polyethylene terephthalate, polypropylene, polystyrene, and polyester.

19. (canceled)

20. The method of claim 5, wherein the single or limited use item is constructed of one or more of the following: polyethylene terephthalate, polypropylene, polystyrene, and polyester.

21. The method of claim 5, wherein producing oil or a petroleum product from the single or limited use item comprises pyrolysis.
